(19) United States
(12) Patent Application Publication
(10) Pub. No.: US 2010/0305819 A1
(43) Pub. Date: Dec. 2, 2010

(54) METHOD, APPARATUS AND COMPUTER PROGRAM PRODUCT FOR DETERMINING VEHICLE ENGINE REVOLUTIONS PER MINUTE AND GEAR POSITION INFORMATION USING LOCATION INFORMATION

(75) Inventor: Mikko Valtteri Pihlajamaki, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/475,282

(22) Filed: May 29, 2009

(51) Int. Cl. G06F 7/00

(52) U.S. Cl. 701/51

(57) ABSTRACT

An apparatus for determining vehicle gear information and vehicle engine RPM data based in part on usage of location information may include a processor and a memory storing executable computer program code that causes the apparatus to at least perform operations including evaluating first location information identifying one or more positions of a vehicle at respective times in order to determine a speed of the vehicle. The computer program code may further cause the apparatus to compare the determined speed to a first range of speeds that correspond to gears of the vehicle and determine a current gear that the vehicle is operating in based at least in part on the determined speed corresponding to a speed in the first range of speeds associated with a gear. Corresponding computer program products and methods are also provided.

### TECHNOLOGICAL FIELD

Embodiments of the present invention relate generally to determining vehicle engine revolutions per minute (RPM) and gear position information based in part on usage of location information and, more particularly, relate to a method, apparatus, and computer program product for determining when gears should be changed to facilitate enhanced performance of a vehicle.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile communication devices and other computing devices. However, as the ease of information transfer increases, users and businesses continue to demand more functionality from communication devices, particularly mobile communication devices.

In the past, mobile communications devices mainly consisted of cellular telephones capable of conducting only analog voice communications. As mobile communications devices have evolved and become more ubiquitous, expanded communications capabilities, as well as secondary functionality have been made available to users via their mobile communications devices. For example, while many mobile communications devices still provide for primary functionality, such as voice call communications capabilities, many mobile communications devices also provide for music and video playing capabilities, photo and video capturing, location identification and destination routing and the like.

With the wide variety of functionality that is now available on many mobile communications devices, users are continuously desiring and demanding new and different applications that utilize this functionality. Further, as users become more dependent upon mobile communications devices as part of their everyday life, users have begun recognizing the potential for utilizing mobile communications devices in their vehicles. For instance, many users currently use global position system (GPS) features of mobile terminals in their vehicles for determining one or more travel routes. Given the widespread usage of mobile terminals in vehicles it may be beneficial to expand the functionality of mobile terminals to enhance the features of vehicles.

In this regard, it is known that vehicles may utilize tachometers (also referred to herein as revolution counters or rev counters) to measure the rotation speed or revolutions per minute (RPM) of an engine's crankshaft and the tachometers may contain markings indicating a safe range of rotation speeds. The tachometer may assist a driver in selecting appropriate gear settings for driving conditions. Additionally, prolonged use of a gear at high speeds may cause excessive wear and other damage to an engine. Speeds above maximum safe operating speeds typically are indicated by an area of a gauge marked in red. When the gauge reaches the area in red, this condition is typically referred to as redlining an engine or revving up an engine to a maximum safe limit.

One drawback of existing mechanisms for determining the revolutions per minute of an engine of a vehicle and determining gear settings is that these mechanisms are typically expensive and require various components. For instance, in older vehicles, a tachometer is typically driven by root-mean-square (RMS) voltage waves from a low tension side of an ignition coil, whereas on other vehicles engine speed is determined by the frequency from an alternator tachometer output. Revolution (rev) counters may also be driven by a rotating cable from a drive unit fitted to an engine, typically on a camshaft. In many modern vehicles, a signal for the rev counter is usually generated from an engine electronic control unit (ECU) which derives the information from either a camshaft speed sensor or a crankshaft.

Because the existing mechanisms for determining vehicle RPM and gear settings utilize various sensors and connections to the engine, transmission or other equipment of the vehicle, the existing mechanisms can be quite expensive.

Accordingly, it may be desirable to provide a mechanism of utilizing a terminal (e.g., mobile terminal) to determine vehicle engine revolutions per minute, gear position information as well as information indicating when a gear should be changed based at least in part on usage of GPS data.

### BRIEF SUMMARY

A method, apparatus and computer program product are therefore provided according to embodiments of the present invention for determining vehicle engine RPM, gear position information of a vehicle and information indicating whether a gear of a vehicle should be changed based in part on using location information. In this regard, the exemplary embodiments may utilize location information such as for example GPS data associated with time, speed and location information of a mobile or fixed terminal to calculate vehicle gear information and vehicle engine RPM data.

In this regard, the exemplary embodiments are configured to use location information (e.g., coordinates of latitude and longitude as well as altitude data) of a terminal within a vehicle to determine positions of the vehicle at respective times in order to determine a current speed of the vehicle as well as the acceleration of the vehicle (e.g., the change in velocity of the vehicle over time). The determined speeds of the vehicle may be compared with data that may be stored in one or more tables specifying ranges of optimal speeds in which gears of the vehicle may be operated safely in order to enhance engine performance, minimize excessive wear on parts of the engine and enhance gas consumption of the vehicle.

The exemplary embodiments are also configured to determine whether a gear of a vehicle was changed, for example, shifted up or down to a higher or lower gear on the basis of evaluating the acceleration of the vehicle during time periods and evaluating ranges of speeds corresponding to respective gears in order to determine which gear the vehicle was changed to and if the gear was not changed this information may be used to generate an indication informing a driver that a gear should be changed to another gear in order to enhance the operation of the vehicle and minimize damage to the engine. The exemplary embodiments may also calculate vehicle RPM data based in part on the detected speed of the vehicle which may be generated based on location information and the RPM data and information identifying the speed in which the vehicle may be traveling may be shown on an electronic dashboard so as to minimize costs that are associated with deploying vehicles with physical dashboards that may house various devices such as speedometers, RPM gauges, etc. Since the exemplary embodiments are configured to calculate vehicle engine RPM data and gear position information based in part on using location information, usage of the exemplary embodiments in vehicles may result in costs savings since traditionally various physical components such as for example sensors and wired connections to parts of an engine are typically utilized to determine RPM data and gear position information.

In one exemplary embodiment, a method for determining gear information of a vehicle and vehicle engine RPM data based in part on usage of location information is provided. The method may include evaluating first location information identifying one or more positions of a vehicle at respective times to determine a speed of the vehicle. The method may further include comparing the determined speed to a first range of speeds corresponding to gears of the vehicle and determining a current gear that the vehicle is operating in based at least in part on the determined speed corresponding to a speed in the first range of speeds that is associated with one of the gears.

In another exemplary embodiment, a computer program product for determining gear information of a vehicle and vehicle RPM data based in part on usage of location information is provided. The computer program product includes at least one computer-readable storage medium having computer-executable program code instructions stored therein. The computer-executable program code instructions may include program code instructions for evaluating first location information identifying one or more positions of a vehicle at respective times in order to determine a speed of the vehicle. The program code instructions may also compare the determined speed to a first range of speeds that correspond to gears of the vehicle and may determine a current gear that the vehicle is operating in based at least in part on the determined speed corresponding to a speed in the first range of speeds that is associated with one of the gears.

In another exemplary embodiment, an apparatus for determining gear information of a vehicle and vehicle engine RPM data based in part on usage of location information is provided. The apparatus may include a processor and a memory including computer program code. The memory and the computer program code are configured to, with the processor, cause the apparatus to at least perform operations including evaluating first location information identifying one or more positions of a vehicle at respective times in order to determine a speed of the vehicle. The computer program code may further cause the apparatus to compare the determined speed to a first range of speeds that correspond to gears of the vehicle and may determine a current gear that the vehicle is operating in based at least in part on the determined speed corresponding to a speed in the first range of speeds that is associated with one of the gears.

Embodiments of the invention may provide a method, apparatus and computer program product for determining vehicle engine RPM and gear position data by utilizing, in part, location information. As a result, for example, fixed terminal and mobile terminal users may enjoy improved capabilities for determining engine RPM data and vehicle gear information.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of an apparatus for determining vehicle engine RPM data and gear information based in part on using location information according to an exemplary embodiment of the invention;

FIG. 3 illustrates an instrument cluster or electronic dashboard displayed via a device according to an exemplary embodiment of the invention; and

FIGS. 4A & 4B illustrate a flowchart for determining vehicle gear information and vehicle RPM data based in part on using location information according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention. Additionally, in some embodiments data, content, information or the like may include location information in which GPS data is one example that will be referred to throughout for purposes of illustration, but not of limitation.

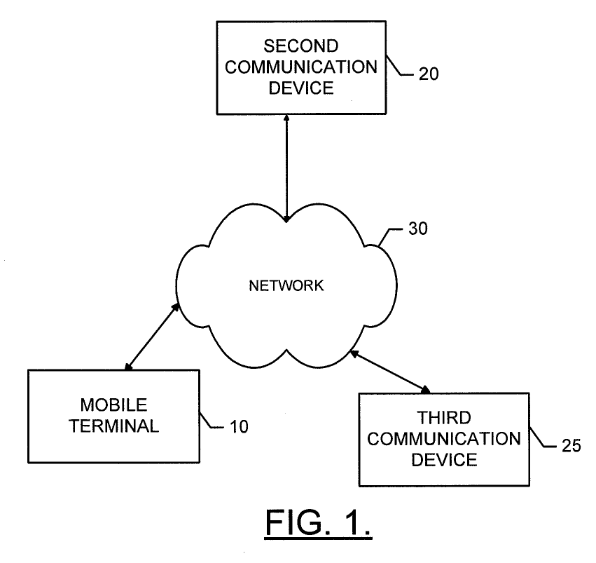

FIG. 1 illustrates a block diagram of a system that may benefit from embodiments of the present invention. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively. Additionally, it should be pointed out that the second and third communication devices 20 and 25 may be in communication with each other via the network 30 and each may transmit signals to and receive signals from one or more satellites that are configured to monitor the location of mobile terminals. In this regard, the second and third communication devices 20 and 25 which may receive the signals from the satellites may transmit the signals to mobile terminals (e.g., mobile terminal 10). The signals transmitted by the second and third communication devices 20 and 25 to the mobile terminals may contain data indicating a position (e.g., longitude, latitude, altitude, etc.) of the mobile terminals at a given time.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, Wireless LAN (WLAN), Worldwide Interoperability for Microwave Access (WiMAX), WiFi, Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like. Additionally, it should be pointed out that the mobile terminal 10 and the second and third communication devices 20 and 25 may communicate with each other via one or more communication channels. In this regard, the mobile terminal 10 and the second and third communication devices 20 and 25 may utilize the communication channels to exchange GPS data between each other as well as any other suitable data, information, content or the like.

In example embodiments, the first communication device (e.g., the mobile terminal 10) may be a mobile communication device such as, for example, a wireless telephone or other devices such as a personal digital assistant (PDA), mobile computing device, camera, video recorder, audio/video player, global positioning system (GPS) device, game device, television device, radio device, or various other like devices or combinations thereof. The second and third communication devices 20 and 25 may be mobile or fixed communication devices and may, but need not, be network devices. However, in one example, the second and third communication devices 20 and 25 may be remote computers or terminals such as personal computers (PC) or laptop computers.

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a positioning sensor (e.g., GPS device) configured to determine a location of the device, such as latitude and longitude coordinates of the device (e.g., mobile terminal 10) or a position relative to a reference point such as a destination or a start point. In addition, the positioning sensor is configured to determine the speed and acceleration of a moving vehicle, when a device that includes the positioning sensor is located in the vehicle.

In an exemplary embodiment, the mobile terminal 10 and the second and third communication devices 20 and 25 may be configured to include the positioning sensor. However, in other alternative embodiments the mobile terminal 10 and one of the second and third communication devices 20 and 25 may include a positioning sensor. The communication device (e.g., third communication device 25) that does not include a positioning sensor may be a network device (entity) that receives signals from one or more satellites. The signals received from the satellite may contain data indicating the location of one or more devices (e.g., mobile terminal 10 and second communication device 20) and may indicate the time that the devices were located by the satellite(s).

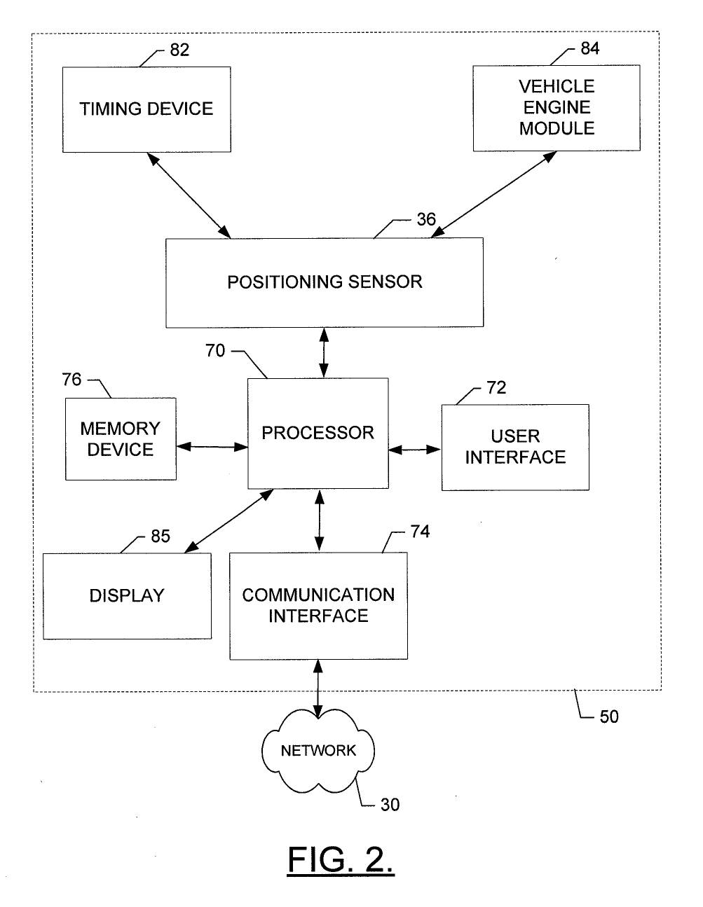

In an exemplary embodiment, the mobile terminal 10 as well as the second and third communication devices 20 and 25 may employ an apparatus (e.g., apparatus of FIG. 2) capable of employing embodiments of the present invention.

FIG. 2 illustrates a block diagram of an apparatus that may benefit from embodiments of the present invention. It should be understood, however, that the apparatus as illustrated and hereinafter described is merely illustrative of one apparatus that may benefit from embodiments of the present invention and, therefore, should not be taken to limit the scope of embodiments of the present invention. In one exemplary embodiment, the apparatus of FIG. 2 may be employed on a mobile terminal (e.g., mobile terminal 10) capable of communication with other devices via a network (e.g., network 30). The mobile terminal may be utilized in a variety of environments including but not limited to usage in a vehicle. However, in some cases, the apparatus on which embodiments of the present invention are practiced may be a fixed terminal and/or a terminal that does not communicate with other devices. The fixed terminal may be integrated in a vehicle. In this regard, the fixed terminal may be a device that is not easily detachable from the vehicle and which moves with the vehicle as the vehicle moves. The mobile or fixed terminals may determine RPM data and gear information for vehicles having manual, semi-automatic or automatic transmissions. It should be pointed out that, not all systems that may employ embodiments of the present invention are described herein. Moreover, other structures for apparatuses employing embodiments of the present invention may also be provided and such structures may include more or less components than those shown in FIG. 2. Thus, some embodiments may comprise more or less than all the devices illustrated and/or described herein. Furthermore, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

FIG. 2 illustrates a schematic block diagram of an apparatus for determining vehicle engine RPM data and vehicle gear position information based at least in part on usage of GPS data according to an exemplary embodiment. An exemplary embodiment of the invention will now be described with reference to FIG. 2, in which certain elements of an apparatus 50 for generating vehicle RPM data and vehicle gear position information are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some of the devices or elements may be omitted in certain embodiments.

Referring now to FIG. 2, an apparatus 50 for generating vehicle RPM data and vehicle gear position information is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, directories, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content. Additionally, it should be pointed out that the memory device may also be configured to store one or more tables containing data indicating maximum speeds in which respective gears of a vehicle should operate in order to minimize damage to the engine of a vehicle or other components of the vehicle. The data in the tables may be evaluated by the processor 70 in determining whether a gear should be changed.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may otherwise be a general purpose processing element or other functionally configurable circuitry if not for the specific configuration provided by the instructions, to perform the algorithms and operations described herein. However, in some cases, the processor 70 may be a processor of a specific device (e.g., a mobile terminal) adapted for employing embodiments of the present invention by further configuration of the processor 70 by instructions for performing the algorithms and operations described herein.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). The communication interface 74 may receive and/or transmit data via one or more communication channels. In this regard, the communication interface 74 may receive data or one or more signals from a network device (e.g., third communication device 25) containing information indicating a location (e.g., longitude and/or latitude coordinates) of the apparatus at a given time. In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

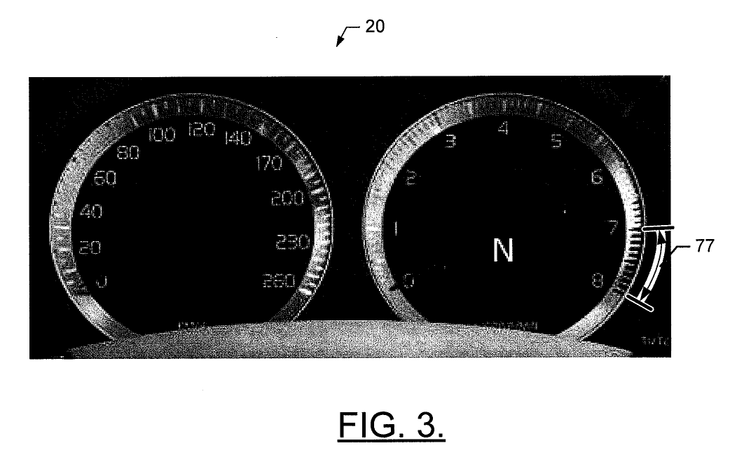

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display 85, a touch screen, a microphone, a speaker, or other input/output mechanisms. The apparatus may, but need not include a battery, such as a vibrating battery pack, for powering various circuits that may be required to operate the apparatus, as well as optionally providing mechanical vibration as a detectable output. The apparatus may also include a vibrating device to provide the mechanical vibration as a detectable output. In this regard, the vibration generated by the vibrating device may be used as an indicator for an optimal time in which to change a gear. The vibration may be generated based on receipt of a signal by the processor 70 in response to the processor 70 determining that an operating speed of a vehicle is approaching a critical level (which may be denoted by a redline of an RPM gauge) for a given gear. Based on the vibration of the apparatus 50, a driver of a vehicle may realize that a gear needs to be changed, without requiring the driver to look at a dashboard containing RPM and speed data. In this regard, the driver may be better equipped to focus on driving, rather than looking at RPM gauges and possibly being distracted from focusing on driving. In an exemplary embodiment in which the apparatus is embodied as a server or some other network devices, the user interface 72 may be limited, remotely located, or eliminated. The display may be a liquid crystal display (LCD) configured to display an electronic dashboard containing engine RPM data and speed data (See FIG. 3) as well as any other suitable data.

The apparatus 50 may include a positioning sensor 36. The positioning sensor 36 may be in communication with processor 70, a timing device 82 and a vehicle module 84. The positioning sensor 36 may include, for example, a global positioning system (GPS) sensor, an assisted global positioning system (Assisted-GPS) sensor, a Bluetooth (BT)-GPS mouse, or other GPS or positioning receivers or the like. In one embodiment, however, the positioning sensor may include a pedometer or inertial sensor. In another embodiment, the positioning sensor may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the positioning sensor as described below. Thus, in examples in which software is employed, a device or circuitry (e.g., processor 70 in one example) executing the software forms the structure associated with such means. In this regard, for example, the positioning sensor 36 may be configured to generate, among other things, GPS data that may be used by the processor of apparatus in determining vehicle engine RPM data and gear information associated with the vehicle.

It should be pointed out that the timing device 82 and the vehicle engine module 84 may be located external or internal to the positioning sensor 36. The timing device 82 and the vehicle engine module 84 may be in communication with the processor 70 (via the positioning sensor 36). The timing device 82 and the vehicle engine module 84 may be embodied in a computer program product as instructions that are stored in memory of a communication device (e.g., mobile terminal 10 and/or the second or third communication devices 20 and 25) and executed by the processor 70. Alternatively, the timing device 82 and the vehicle engine module 84 may be any device or circuitry operating in accordance with software thereby configuring the device or circuitry to perform the corresponding functions of the timing device and the vehicle engine module as described herein. For instance, the timing device 82 may generate one or more time periods used by the positioning sensor to determine a time period in which a vehicle may be accelerated and a time period in which to determine whether a gear is changed as well as any other suitable time periods. The vehicle engine module 84 may transmit and/or receive data (e.g., GPS data) from the positioning sensor and may use this data to determine which gear of a vehicle is currently being used, suggest another gear to use for enhanced engine performance, determine vehicle engine RPM data and perform additional corresponding functions described more fully below.

It should be pointed out that the positioning sensor 36 may determine the location of the apparatus 50 based upon signal triangulation or other mechanisms. For instance, the positioning sensor 36 may be configured to determine a location of the apparatus based on receipt of latitude and longitude coordinates of the apparatus which may be sent to the apparatus from a network device (e.g., the third communication device 25 in one embodiment). The positioning sensor 36 may also be configured to determine a location of the apparatus by evaluating a position relative to a reference point such as a destination or a start point. Information from the positioning sensor may be communicated to a memory device 76 of the apparatus or to another memory device to be stored as a position history or location information. In this regard, for example, the position history may define a series of data points corresponding to positions of the apparatus 50 at respective times. The positioning sensor 36 may determine the speed and acceleration in which the apparatus is traveling along the route, for example through timed location updates. For instance, the positioning sensor is configured to determine the speed and acceleration in which the apparatus is traveling based on changes in position at respective times. In this regard, the positioning sensor is configured to determine the time that it takes the apparatus to move from a first location to a second location in order to determine the speed in which the apparatus is moving or travelling. When the apparatus is included in or integrated within a vehicle, the speed of the vehicle may be determined based on the speed of the apparatus 50. In an alternative exemplary embodiment, the positioning sensor may include a motion detection unit (e.g., gyrometer with associated algorithms) for obtaining the speed in which the apparatus is traveling or moving.

It should be pointed out that the memory device of the apparatus may store instructions for determining cell id information. In this regard, the memory device may store an application program for execution by the processor 70, which determines an identity of the current cell, i.e., cell id identity or cell id information, with which the apparatus is in communication. The positioning sensor may utilize the cell id information to more accurately determine a location of the apparatus.

In an exemplary embodiment, the positioning sensor may be configured to detect a change in velocity over time (e.g., acceleration) of the apparatus 50. For instance, the positioning sensor 36 may determine whether a vehicle speeds up, slows down or stops during a predetermined time interval (e.g., 3 seconds). The predetermined time interval may be generated by the timing device 82. In this regard, the positioning sensor 36 may periodically monitor the acceleration of the vehicle according to a time associated with the predetermined time interval. Based on a rate in which the vehicle's speed may change during the predetermined time interval, the positioning sensor 36 may assign a value to the detected acceleration.

In an exemplary embodiment, the positioning sensor 36 may assign values to the acceleration for each increase in speed by a factor of 10 km/hr during the predetermined time interval. In this regard, when the positioning sensor 36 detects that the speed of a vehicle increases during the predetermined time interval (e.g., also referred to herein as predetermined time period) by 10 km/hr, the positioning sensor 36 may assign an acceleration value of 1 and when the positioning sensor 36 detects that the speed of the vehicle increases during the predetermined time interval by 20 km/hr, the positioning sensor 36 may assign an acceleration value of 2. Additionally, when the positioning sensor 36 detects that the speed of the vehicle increases during the predetermined time interval by a speed of 30 km/hr, the positioning sensor may assign an acceleration value of 3, so on and so forth.

On the other hand, when the positioning sensor determines that the speed of the vehicle decreases by a factor of 10 km/hr during the predetermined time interval, the positioning sensor 36 may assign a value of −1 associated with the deceleration. In this regard, if the positioning sensor determines that the speed of the vehicle is decreased by 20 km/hr, the positioning sensor may assign a value of −2 associated with the deceleration, so on and so forth. Although the examples above describe instances in which the positioning sensor may assign acceleration values on the basis of speed increases of a factor of 10 km/hr during a predetermined time period, it should be pointed out that the assignment of the acceleration values may be based on a factor of different speed increases (e.g., 15 km/hr, 25 km/hr, 35 km/hr, etc.) without departing from the spirit and scope of the invention.

When the positioning sensor 36 detects that the speed of the vehicle has not changed (e.g., steady state) or is zero during a predetermined time interval, the positioning sensor 36 may assign an acceleration value of zero. The positioning sensor 36 may detect that the speed of the vehicle has not changed during the predetermined time interval in situations in which the speed of the vehicle remains constant, for example driving at a speed of 70 km/hr for given time period (e.g., 10 seconds, etc.). It should be pointed out that the positioning sensor 36 may determine that the acceleration of the vehicle is zero during the predetermined time period in instances in which a gear is being changed or shifted to another gear, since the speed of the vehicle is typically not increased while a gear is changed. Additionally, the positioning sensor 36 may determine that the acceleration of the vehicle is zero when the vehicle is not moving or is stopped. These acceleration values determined by the positioning sensor 36 may be used in determining a current gear position and determining whether a gear needs to be changed to another gear (e.g., higher or lower gear) in a manner described more fully below.

In an exemplary embodiment, the positioning sensor 36 may determine the speed of the vehicle based on locations (e.g., GPS data) of the apparatus at respective times in the manner described above, for example, and the data associated with the speed of the vehicle may be sent to the vehicle engine module 84 which may compare the determined speed (e.g., 15 km/hr) to data in a maximum speed table such as the maximum speed table set forth below.

Maximum Speed Table

| Gear | Max Speed (km/hr) |
|---|---|
| Neutral (N) | 0 |
| 1 | 1-29 |
| 2 | 30-59 |
| 3 | 60-89 |
| 4 | 90-119 |
| 5 | 120 and above |

The maximum speed table specifies a range of speeds (e.g., 1-29 km/hr) in which respective gears (e.g., for gear 1) of a vehicle may be safely operated. The optimal range of speeds in which each gear should be operated may be determined by evaluating historical RPM data at given speeds for gears of various vehicles. In an alternative exemplary embodiment, the optimal range of speeds in which each gear should be operated may be calibrated by software of the apparatus that may be executed by the processor. Moreover, a user may utilize a pointing device of the apparatus 50 to select the calibration software for execution by the processor 70. The calibration software may automatically set the maximum operating ranges of the speeds for each gear when a driver accelerates a vehicle from 0 km/hr to 120 km/hr for example, preferably on a roadway free of cars and debris. As the vehicle accelerates and the RPM approaches a maximum value before reaching a red-line or critical value (See e.g., element 77 of FIG. 3) of a RPM gauge or meter, the driver or the vehicle may change the gear and as the driver or vehicle changes each gear according to this mechanism, the calibration software is configured to determine the maximum safe operating speeds for each gear of a vehicle and this data may be saved in the maximum speed table and stored in memory device 76. It should be pointed out that the ranges of the speeds in the maximum speed table are examples of ranges of speeds in which a gear should be operated under optional conditions. However, other ranges of speeds may be contained in the maximum speed table based on the type of vehicle, type of gears, etc. without departing from the spirit and scope of the invention. Operation of the gears of a vehicle in the appropriate range of speed designated in the maximum speed table may result in optimal gas consumption and performance of the vehicle since the respective gear would typically not be stressed if the appropriate speed is utilized.

It should be pointed out that the vehicle engine module 84 may utilize the data in the maximum speed table as a reference for indicating which gear should be currently in use. For instance, if the speed of the vehicle is 15 km/hr, the vehicle engine module 84 may evaluate data in the maximum speed table and determine that gear 1 of the vehicle should currently be in use for optimal usage of the vehicle's engine, since gear 1 may correspond to a maximum speed range of 1-29 km/hr. If the speed of the vehicle exceeds the maximum operating speed (e.g., 35 km/hr) for a given gear (e.g., gear 1) and the vehicle engine module 84 receives a signal from the positioning sensor 36 indicating that a gear has not been changed during a time interval in which the vehicle is accelerated, the vehicle engine module 84 may generate an indicator that may be sent to a display of the apparatus and the indicator may specify that the current gear should be changed to a higher gear. The positioning sensor 36 may determine that a gear has not been changed when the positioning sensor 36 does not detect a pause in acceleration during a time interval in which the vehicle is accelerated and in this regard the positioning sensor 36 may send the vehicle engine module 84 a signal indicating that a gear was not changed. The failure to detect a pause in acceleration, by the positioning sensor 36, when the vehicle is accelerated during a time period may denote to the positioning sensor 36 that a gear is not changed since the acceleration of a vehicle during a gear change is typically zero or is negligible—in other words, a vehicle is not typically accelerated while a gear is being changed or shifted. In this regard, if the positioning sensor 36 does not detect a pause in acceleration (e.g., zero acceleration) during a time period in which a vehicle is accelerated (e.g., accelerated from 50 km/hr to 70 km/hr during a time period of 10 seconds, for example) the positioning sensor 36 may determine that a gear has not been changed.

In an exemplary embodiment, the vehicle engine module 84 may determine that a gear is changed in response to receiving a signal from the positioning sensor indicating that the positioning sensor 36 detects a pause in acceleration (e.g., zero acceleration) of the vehicle, associated with a time in which it takes to shift a gear, followed by an increase in acceleration of the vehicle. The increase in acceleration of the vehicle may be due to a driver depressing a gas pedal to increase (or control electronics (e.g., cruise control device) increasing) the speed after the gear is changed to a higher gear for example.

It should be pointed out that in vehicles having a manual transmission, the pause in acceleration may also include a time in which a clutch is depressed and a gear is changed or shifted. In vehicles having automatic and/or semi-automatic transmissions, the pause in acceleration may include the time it takes the transmission to automatically change a gear. In an exemplary embodiment, the time interval associated with changing a gear may be 2 seconds for vehicles having manual, automatic or semi-automatic transmissions. However, the time associated with changing a gear may be any other suitable time without departing from the spirit and scope of the invention. It should be pointed out that the time interval associated with changing a gear may be generated by the timing device 82.

An exemplary embodiment in which the apparatus of FIG. 2 may detect that a gear of a vehicle is changed to a higher gear (also referred to herein as “gear change up”) will now be described with reference to acceleration information and the gear change up table set forth below.

Gear Change Up Table

| Gear | Speed (km/hr) |
|---|---|
| Neutral (N) | 0 |
| 1 | 1-30 |
| 2 | 20-60 |
| 3 | 40-90 |
| 4 | 60-120 |
| 5 | 90 and above |

It should be pointed out that the range of speeds corresponding to each of the gears in the gear change up table may be determined based on evaluation of historical data relating to optimal ranges of speeds in which gears of a vehicle may be changed to a higher gear in order to maintain optimal and efficient use of the vehicle. Additionally, it should be pointed out that the range of speeds associated with each gear serves as examples of ranges of speeds in which a gear may operate under optimal conditions. As such, the ranges of speeds in the gear change up table associated with respective gears may consist of different speeds based on a type of vehicle, type of gear, etc. without departing from the spirit and scope of the invention.

Additionally, in an alternative exemplary embodiment, the ranges of speeds associated with each gear in the gear change up table may be calibrated upon execution of calibration software executed by processor 70 in a manner analogous to that described above with respect to the maximum speed table. In particular, the processor 70 may determine appropriate ranges of speed for shifting a gear to a higher gear when a vehicle is accelerated from 0 km/hr to 120 km/hr, for example. The calibration may be based on normal gear shifts occurring at approximately 3000 RPM and the corresponding speed information may be saved in the gear change up table by the processor 70 and may be stored in a memory device such as memory device 76.

As an example of a situation in which the apparatus of FIG. 2 detects that a gear is changed to a higher gear, consider a scenario in which a driver is driving a vehicle at a speed 20 km/hr and then accelerates the vehicle to 60 km/hr. In this regard, the positioning sensor 36 may detect that the vehicle is traveling at a speed 20 km/hr based on information identifying the position or location (e.g., GPS data) of the apparatus at respective times for example. In response to the positioning sensor 36 detecting that the speed of a vehicle is 20 km/hr, the positioning sensor 36 may determine that the vehicle should be operating in gear 1 based on a comparison of the maximum speed ranges identified in the maximum speed table. For instance, the maximum speed table indicates that gear 1 may be safely operated for speeds in the 1-29 km/hr range.

During an observation time interval (e.g., 3 seconds), which may be periodic, the positioning sensor 36 may evaluate whether the speed of the vehicle is increased by a predetermined amount (e.g., by a factor of 10 km/hr) and when the positioning sensor 36 determines that the speed is increased by the predetermined amount during the observation time interval, the positioning sensor 36 may assign an acceleration value (e.g., an acceleration value of 1 based on an increase in speed of 10 km/hr, acceleration value of 2 for speed increase of 20 km/hr, etc.) to the detected acceleration based on the increase in speed (e.g., 30 km/hr). When the acceleration value is a positive integer (e.g., a value of 1, 2, 3, etc.), the timing device 82 in communication with the positioning sensor 36 may begin a time period (also referred to herein as gear change time period) in which to detect whether there is a pause or interruption in the acceleration (e.g., zero acceleration). In an exemplary embodiment, the pause in acceleration may be required to last for the duration of the gear change time period (e.g., 2 seconds) in order for the positioning sensor 36 to detect the pause. In an alternative exemplary embodiment, the pause in acceleration may be required to last for less than (e.g., 1 second) the duration of the gear change time period (e.g., 2 seconds) in order for the positioning sensor to detect the pause.

In response to the positioning sensor detecting a pause or interruption in the acceleration during the gear change time period, the positioning sensor may determine if the acceleration of the vehicle is resumed at a rate sufficient to assign a positive acceleration value to the resumed acceleration. As described above, the positioning sensor may determine that the rate of acceleration is sufficient to assign a positive value based on the speed (e.g., 40 km/hr) of the vehicle increasing by a predetermined amount (e.g., by a factor of 10 km/hr) during an observation time interval (e.g., three seconds or any other suitable time). In response to assigning a positive value to the acceleration that may occur after a pause, break or interruption in a previous detection of acceleration and determining whether the current speed (e.g., 40 km/hr) of the vehicle corresponds to a higher gear based on an evaluation of the gear change up table (e.g., 40 km/hr is outside of the speed range for gear 1), the positioning sensor 36 may determine that gear 1 of the vehicle was shifted or changed to gear 2.

In this regard, the positioning sensor may be configured to determine that a gear was shifted during the break or interruption in acceleration. The break or interruption in the acceleration may denote a gear change since the acceleration of a vehicle is typically zero when a gear is changed and the break in acceleration is followed by continued acceleration of the vehicle. The positioning sensor may also determine whether a current speed of the vehicle is in a range corresponding to a gear in the gear change up table in order to determine which higher gear the vehicle was changed to, which is gear 2 in this example.

The positioning sensor may send data to the vehicle engine module 84 indicating that the gear was changed from gear 1 to gear 2 and the vehicle engine module 84 may send an indication to a display (e.g., display 85) of the apparatus 50 indicating the gear change from gear 1 to gear 2.

It should be pointed out if the positioning sensor 36 does not detect a pause, break or interruption in acceleration in the example above but determines that the acceleration of the vehicle is increased during an observation time interval, the positioning sensor may be configured to determine that a gear was not changed, even if the speed of the vehicle may be increasing to levels that are not optimal for a given gear. In this regard, the positioning sensor 36 may send data to the vehicle engine module 84 informing the vehicle engine module that the gear should be changed to maintain optimal performance of the vehicle and the vehicle engine module may send an indication (via positioning sensor 36 and processor 70) to a display such as display 85 of the apparatus causing data to be shown on the display indicating that the gear should be changed to a higher gear for optimal performance of the vehicle's engine.

An exemplary embodiment in which the apparatus of FIG. 2 may detect that a gear of a vehicle is changed or shifted to a lower gear (also referred to herein as “gear change down”) will now be described with reference to acceleration information and the gear change down table set forth below.

Gear Change Down Table

| Gear | Speed (km/hr) |
|---|---|
| Neutral (N) | 0 |
| 1 | 1-15 |
| 2 | 16-30 |
| 3 | 31-50 |
| 4 | 51-70 |
| 5 | 71 and above |

The range of speeds corresponding to each of the gears in the gear change down table may be determined based on evaluation of historical data relating to optimal ranges of speeds in which gears of a vehicle may be changed to a lower gear in order to maintain optimal and efficient use of the vehicle. Alternatively, the range of speeds may be determined upon execution of the calibration software by the processor 70, which may detect optimal speeds in which to change a gear to a lower gear when a vehicle is decelerating from 120 km/hr to 0 km/hr for example. The ranges of the speeds in the gear change down table are examples of ranges of speeds in which a gear should be changed or shifted to a lower gear. However, other ranges of speeds may be contained in the gear change down table based on the type of vehicle, type of gear, etc. without departing from the spirit and scope of the invention.

The positioning sensor 36 of the apparatus 50 may determine that a gear of a vehicle should be shifted or changed to a lower gear in response to the positioning sensor detecting that the speed of the vehicle is decreasing by a predetermined amount (e.g., by a factor of 10 km/hr) during a predetermined time interval (e.g., 3 second or any other suitable time interval). In this regard, the positioning sensor 36 may assign a negative acceleration value (e.g., −1) to the deceleration detected during the time period. Based on the current speed detected by the positioning sensor 36 and assignment of a negative acceleration value during a time period, the positioning sensor may evaluate data in the gear change down table and determine which gear the vehicle should be changed down or lowered to. For instance, if the positioning sensor 36 determines that a speed of a vehicle is decelerating to 20 km/hr, during a time period, the positioning sensor 36 may evaluate the gear change down table and determine that the gear should be lowered to gear 2.

In this regard, the positioning sensor 36 may send the vehicle engine module 84 an indication specifying that the gear should be lowered to gear 2 and the vehicle engine module 84 may send data to the display 85 (via positioning sensor 36 and processor 70) indicating that the gear should be changed to a lower gear such as gear 2 in this example. Moreover, it should be pointed out that the positioning sensor 36 may continue to monitor for deceleration during predetermined time periods until the vehicle is stopped.

Consideration will now be given to the manner in which the apparatus of FIG. 2 may determine vehicle engine RPM data. In this regard, the vehicle engine module 84 may utilize a RPM equation in order to determine RPM data in which RPM=(s−SFV)×GFV where:
s=speed of the vehicle;
SFV=a variable to indicate a factor for how much each gear affects the RPM when compared to speed; and
GFV=a variable to indicate a factor in which each gear affects the RPM.
   It should be pointed out that the values associated with SFV and the GFV may be based on calibrations and estimations of the affects of speed for a given gear on RPM as well as the affects that each gear has on RPM. In this regard, the SFV and GFV values may be dependent on vehicle gear transmission and an engine type of the vehicle and SFV and GFV values may be set or calibrated manually for different gear ratios and engine types. For example, a diesel tractor may have an entirely different gear transmission and engine type than another vehicle such as for example a sports car. In this regard, the speed of the tractor in 5^{th} gear may be 60 km/hr at 4000 RPM whereas a sports car driving in 5^{th} gear at 4000 RPM may be traveling approximately 180 km/hr. As such, a tractor's 5^{th} gear may be set or calibrated manually to have an SFV of approximately 15 and a GFV of 85. When the tractor is being driven at a speed of 60 km/hr, the vehicle engine module 84 may determine that the corresponding RPM is 3825 (e.g., (60−15)×85=3825 RPM).

As another example of the calculation of RPM data by the vehicle engine module 84, consider a situation in which a vehicle is operating in gear 2 and the vehicle's speed is 40 km/hr. Based on calibrations and estimations with respect to gear 2, the SFV is 20 and the GFV is 143. As such, the vehicle engine module 84 may determine that the optimal RPM for gear 2 is 2860 RPM (e.g., (40−20)×143=2860 RPM).

Additional examples of the SFV and GFV values for each gear are set forth below.
SFV values for gears 1-5 and neutral:
SFV=1 for Neutral gear
SFV=1 for 1st gear
SFV=20 for 2nd gear
SFV=40 for 3rd gear
SFV=60 for 4th gear
SFV=80 for 5th gear
GFV values for gears 1-5 and neutral:
GFV=1 for Neutral gear
GFV=110 for 1st gear
GFV=143 for 2nd gear
GFV=133 for 3rd gear
GFV=110 for 4th gear
GFV=100 for 5th gear

As additional examples of the vehicle engine module 84 calculating RPM data for gears consider the following examples in which:
Speed of vehicle=100;
Gear=4th Gear.
SFV=60 for 4th gear; and
GFV=110 for 4th gear;
   In this regard, the vehicle engine module 84 may determine that when a vehicle is traveling at a speed of 110 km/hr while operating in the 4^{th} gear, the corresponding RPM=4400 (e.g., (100−60)×110=4400 RPM).

When the gear is changed to the 5^{th} gear, the value of the RPM may be lowered. For example, when the speed of the vehicle is 100 km/hr and the vehicle is operating in the 5^{th} gear, the vehicle engine module 84 may determine that the RPM=2000 (e.g., (100−80)×100=2000 RPM).

It should be pointed out that the values of the SFVs and the GFVs described above are examples which are based on calibrations and estimations and in this regard, the values of the SFVs and GFVs may be different than those described above without departing from the spirit and scope of the invention.

Referring now to FIG. 3 an exemplary embodiment of an instrument cluster or electronic dashboard according to an exemplary embodiment is provided. The electronic dashboard may be generated by the vehicle engine module 84 and may be shown on a display (e.g., display 85) of the apparatus 50. The electronic dashboard contains data indicating an electronic speedometer and an RPM gauge. The RPM gauge denotes that when the RPM of the engine is in the range of 7000-8000 RPM the engine may be operating in an unsafe or inefficient manner. In this regard, the 7000-8000 RPM range is denoted by areas with red markings 77 (e.g., red-lines) to indicate that the engine may be operating at undesirable and potentially unsafe levels. By utilizing an electronic dashboard, the apparatus of the exemplary embodiments may allow space to be saved on a physical dashboard of a vehicle which may result in cost reductions associated with deploying physical dashboards in vehicles.

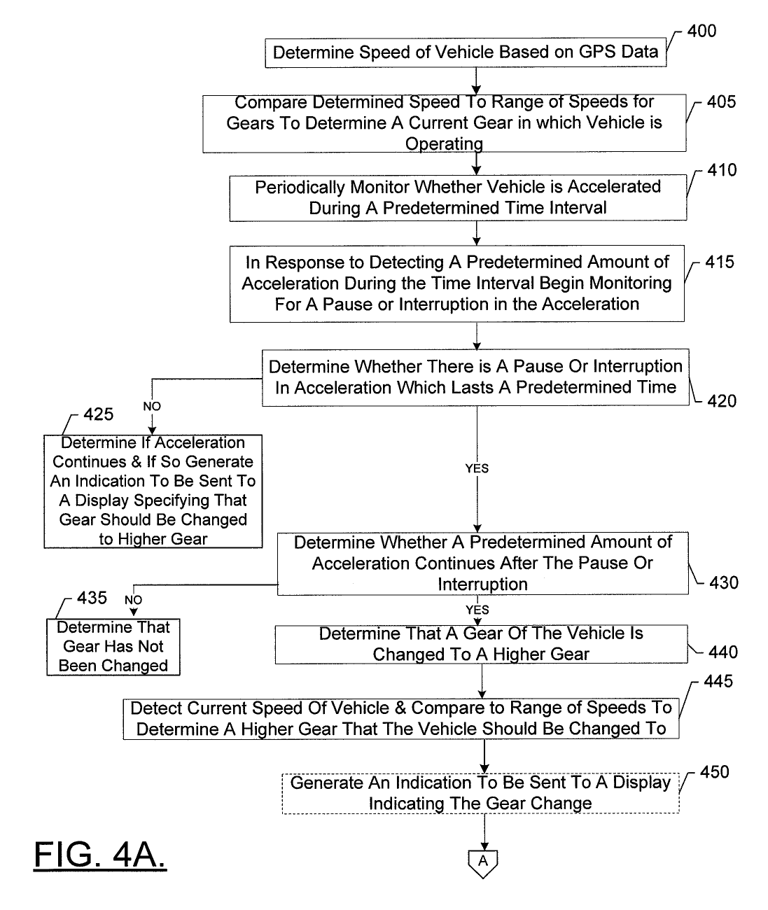

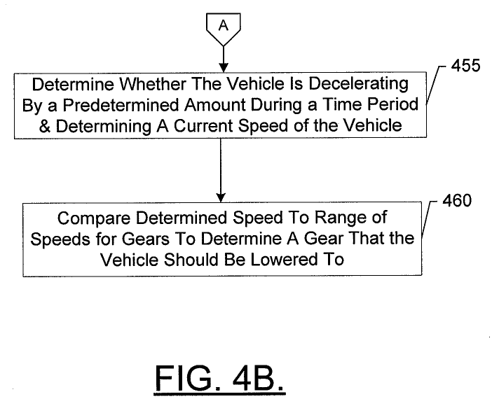

Referring now to FIGS. 4A & 4B, a flowchart for determining vehicle gear information and vehicle engine RPM data based in part on usage of GPS data is provided. At operation 400, the speed of a vehicle may be determined based on GPS data. In this regard, a positioning sensor 36 within the vehicle may determine the speed based on location or position information (e.g., latitude, longitude, altitude data, etc.) relating to the locations (e.g., GPS data) of the vehicle at respective times. Alternatively, the speed of the vehicle may be determined by a device such as a gyrometer within the positioning sensor 36 or any other suitable device capable of determining speed. At operation 405, the determined speed may be compared to a range of speeds to determine a current gear in which the vehicle is operating. In an exemplary embodiment, the positioning sensor 36 may compare the detected speed to a range of speeds in a maximum speed table in order to determine a current gear in which the vehicle is operating. At operation 410, the acceleration of the vehicle may be periodically monitored during a predetermined time interval. In an exemplary embodiment, the positioning sensor 36 monitors the speed of the vehicle every 3 seconds to determine if the vehicle is accelerated. However, a different monitoring time may be used without departing from the spirit and scope of the invention.

At operation 415, in response to detecting a predetermined amount of acceleration (e.g., a positive acceleration value for example; e.g., an increase in speed by a factor of 10 km/hr) during the monitored time period, the positioning sensor 36 may periodically monitor (e.g., every 3 seconds) for a pause, break or interruption in the acceleration. At operation 420, the positioning sensor 36 may determine whether there is a pause, break or interruption in the acceleration which lasts a predetermined time (e.g., 2 seconds, etc.) At operation 425, if the positioning sensor does not detect a pause or break in acceleration upon the expiration of a time period (e.g., 9 seconds) but determines that the acceleration continues, the positioning sensor may send data to a vehicle engine module 84 which may generate an indication that is sent to a display indicating that a currently used gear should be changed to a higher gear.

At operation 430, in response to detecting a pause or interruption in the acceleration for a predetermined amount of time (e.g., 2 seconds) the positioning sensor may determine whether the acceleration of the vehicle continues to increase by a predefined amount (e.g., by a factor of 10 km/hr) after the interruption. At operation 435, when the positioning sensor determines that the acceleration of the vehicle is not increased by a predefined amount after detection of the interruption, the positioning sensor may determine that a currently used gear of the vehicle was not changed. At operation 440, in response to the positioning sensor detecting that the vehicle's acceleration continues by a predefined amount after the detection of the interruption, the positioning sensor may determine that a gear of the vehicle has been changed to a higher gear. In this regard, a detected pause in the acceleration followed by continued acceleration of the vehicle may indicate that a gear is changed.

At operation 445, the positioning sensor 36 may detect the current speed of the vehicle and compare the detected speed to a range of speeds for a given gear to determine a higher gear that the vehicle should be changed to. In this regard, the positioning sensor may compare the detected speed to a range of speeds in a gear change up table. Optionally, at operation 450, the positioning sensor 36 may send data to the vehicle engine module 84 indicating the gear change and the vehicle engine module 84 may generate an indication that is sent to a display (e.g., display 85) of an apparatus (e.g., apparatus 50) indicating the gear change. At operation 455, the positioning sensor 36 may determine whether the vehicle is decelerating by a predetermined amount (e.g., speed is decreasing by a factor of 10 km/hr) during a time period (e.g., every three second) and the positioning sensor may detect the current speed of the vehicle. At operation 460, the positioning sensor 36 may compare the detected speed during deceleration of the vehicle to a range of speeds for respective gears in order to determine a gear that the vehicle should be lowered to. In this regard, the positioning sensor may compare the detected speed to a range of speeds in a gear change down table in order to determine the gear that the vehicle should be lowered to. Optionally, the vehicle engine module 84 may determine vehicle engine RPM data based on detected speeds of the vehicle and SFV and GFV values where RPM=(s−SFV)×GFV, as described above.

It should be pointed out that FIGS. 4A & 4B are a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., the processor 70). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the method of FIGS. 4A & 4B above may comprise a processor (e.g., the processor 70) configured to perform some or each of the operations (400-460) described above. The processor may, for example, be configured to perform the operations (400-460) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-460 may comprise, for example, the processor 70 (e.g., as means for performing any of the operations described above), the positioning sensor 36 and the vehicle control module 84 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
evaluating first location information identifying one or more positions of at least one vehicle at respective times to determine a speed of the vehicle;
comparing the determined speed to a first range of speeds that correspond to one or more respective gears of the vehicle; and
determining, via a processor, a current gear that the vehicle is operating in based at least in part on the determined speed corresponding to a speed in the first range of speeds associated with one of the gears.

2. The method of claim 1, further comprising:
periodically determining whether the vehicle is decelerated by a predefined amount during a predefined time period;
comparing a determined speed to a second range of speeds corresponding to the gears in response to detection of deceleration of the vehicle by the predefined amount; and
determining that the current gear should be changed to a lower gear of the vehicle based at least in part on the determined speed corresponding to a speed in the second range of speeds associated with at least one of the gears.

3. The method of claim 1, further comprising determining that the first location information comprises at least one of latitude, longitude and altitude data corresponding to at least one location or position of the vehicle.

4. The method of claim 1, further comprising:
periodically determining whether the vehicle is accelerated by a predefined amount; and
determining whether there is a pause or interruption in the acceleration in response to detecting that the acceleration equals or exceeds the predefined amount.

5. The method of claim 4, wherein when the determination does not detect a pause or interruption in the acceleration the method further comprises:
determining whether the vehicle continues to accelerate by the predefined amount; and
generating an indication to be sent to a device indicating that at least one gear of the vehicle should be changed to a higher gear in response to the vehicle continuing to accelerate by the predefined amount.

6. The method of claim 4, further comprising determining whether the duration of the pause or interruption lasts a predetermined amount of time.

7. The method of claim 4, further comprising:
determining whether the vehicle continues to accelerate by a predetermined amount after a detection of the pause or interruption; and
determining that at least one gear of the vehicle is changed to a higher gear in response to detection of the continued acceleration of the vehicle by the predetermined amount.

8. The method of claim 7, further comprising determining that the at least one gear is not changed in response to detecting that the acceleration of the vehicle is not resumed after detection of the pause.

9. The method of claim 7, further comprising:
detecting a current speed of the vehicle based on evaluating second location information identifying one or more different positions of the vehicle at corresponding times;
comparing the current speed to a third range of speeds corresponding to the gears; and
determining a higher gear that the vehicle should be changed to based at least in part on the current speed corresponding to a speed in the third range of speeds associated with a respective one of the gears.

10. An apparatus comprising:
at least one processor; and
at least one memory including computer program code, the at least one memory and the computer program code configured to, with the at least one processor, cause the apparatus to perform at least the following:
evaluate first location information identifying one or more positions of at least one vehicle at respective times to determine a speed of the vehicle;
compare the determined speed to a first range of speeds that correspond to one or more respective gears of the vehicle; and
determine a current gear that the vehicle is operating in based at least in part on the determined speed corresponding to a speed in the first range of speeds associated with one of the gears.

11. The apparatus of claim 10, wherein the computer program code further causes the apparatus to:
periodically determine whether the vehicle is decelerated by a predefined amount during a predefined time period;
compare a determined speed to a second range of speeds corresponding to the gears in response to detection of deceleration by the predefined amount; and
determine that the current gear should be changed to a lower gear of the vehicle based at least in part on the determined speed corresponding to a speed in the second range of speeds associated with at least one of the gears.

12. The apparatus of claim 10, wherein the computer program code further causes the apparatus to determine that the first location information comprises at least one of latitude, longitude and altitude data corresponding to at least one location or position of the vehicle.

13. The apparatus of claim 10, wherein the computer program code further causes the apparatus to:
periodically determine whether the vehicle is accelerated by a predefined amount; and
determine whether there is a pause or interruption in the acceleration in response to detecting that the acceleration equals or exceeds the predefined amount.

14. The apparatus of claim 13, wherein when the determination does not detect a pause or interruption in the acceleration the computer program code further causes the apparatus to:
determine whether the vehicle continues to accelerate by the predefined amount; and
generate an indication to be sent to a device indicating that at least one gear of the vehicle should be changed to a higher gear in response to the vehicle continuing to accelerate by the predefined amount.

15. The apparatus of claim 13, wherein the computer program code further causes the apparatus to determine whether the duration of the pause or interruption lasts a predetermined amount of time.

16. The apparatus of claim 13, wherein the computer program code further causes the apparatus to:
determine whether the vehicle continues to accelerate by a predetermined amount after a detection of the pause or interruption; and
determine that at least one gear of the vehicle is changed to a higher gear in response to detection of the continued acceleration of the vehicle by the predetermined amount.

17. The apparatus of claim 16, wherein the computer program code further causes the apparatus to determine that the at least one gear is not changed in response to detecting that the acceleration of the vehicle is not resumed after detection of the pause.

18. The apparatus of claim 16, wherein the computer program code further causes the apparatus to:
detect a current speed of the vehicle based on evaluating second location information identifying one or more different positions of the vehicle at corresponding times;
compare the current speed to a third range of speeds corresponding to the gears; and
determine a higher gear that the vehicle should be changed to based at least in part on the current speed corresponding to a speed in the third range of speeds associated with a respective one of the gears.

19. A computer program product comprising at least one computer-readable storage medium having computer-readable program code portions stored therein, the computer-readable program code portions comprising:
program code instructions for evaluating first location information identifying one or more positions of at least one vehicle at respective times to determine a speed of the vehicle;
program code instructions for comparing the determined speed to a first range of speeds that correspond to one or more respective gears of the vehicle; and
program code instructions for determining a current gear that the vehicle is operating in based at least in part on the determined speed corresponding to a speed in the first range of speeds associated with one of the gears.

20. The computer program product of claim 19, further comprising:
program code instructions for periodically determining whether the vehicle is decelerated by a predefined amount during a predefined time period;
program code instructions for comparing a determined speed to a second range of speeds corresponding to the gears in response to detection of deceleration by the predefined amount; and
program code instructions for determining that the current gear should be changed to a lower gear of the vehicle based at least in part on the determined speed corresponding to a speed in the second range of speeds associated with at least one of the gears.

21. The computer program product of claim 19, further comprising:
program code instructions for periodically determining whether the vehicle is accelerated by a predefined amount; and
program code instructions for determining whether there is a pause or interruption in the acceleration in response to detecting that the acceleration equals or exceeds the predefined amount.

22. The computer program product of claim 21, wherein when the determination does not detect a pause or interruption in the acceleration, the computer program product further comprises:
program code instructions for determining whether the vehicle continues to accelerate by the predefined amount; and
program code instructions for generating an indication to be sent to a device indicating that at least one gear of the vehicle should be changed to a higher gear in response to the vehicle continuing to accelerate by the predefined amount.
